(19) United States
(12) Patent Application Publication
(10) Pub. No.: US 2024/0076122 A1
(43) Pub. Date: Mar. 7, 2024

(54) Ergonomic Trash Receptacle

(71) Applicant: Christopher Joseph Dorr, Mclean, VA (US)

(72) Inventor: Christopher Joseph Dorr, Mclean, VA (US)

(21) Appl. No.: 18/059,346

(22) Filed: Nov. 28, 2022

Related U.S. Application Data
(60) Provisional application No. 63/283,521, filed on Nov. 28, 2021.

(51) Int. Cl. B65F 1/06

(52) U.S. Cl. CPC B65F 1/068

(57) ABSTRACT

The present invention is an ergonomic trash receptacle that allows for removal of full trash bags outward in a horizontal motion, as opposed to the conventional vertical lifting motion. The trash receptacle achieves this with an anterior opening to allow access to the trash bag. The trash receptacle is comprised of an adjustable retaining rack to hold trash bags open that is comprised of two or more bag holding fixtures, with at least one or more of the bag hold fixtures being able to move relative to the other bag holding fixture(s), as well as the trash receptacle being preferably comprised of a door to seal the anterior opening, with the door being comprised of two or more linked panels that stack on themselves when being moved to the open position.

### CROSS REFERENCE TO RELATED APPLICATION

This application claims the benefit of U.S. Provisional Patent Application No. 63/283,521 filed Nov. 28, 2021, by Christopher Joseph Dorr, and incorporated in its entirety herein by reference.

### FIELD OF THE INVENTION

The present invention, in some embodiments thereof is predicated upon trash holding devices, and specifically, to an ergonomic trash receptacle and system for removal of trash bags in an outward horizontal motion, as opposed to the conventional vertical lifting motion.

### BACKGROUND OF THE INVENTION

The present invention, in some embodiments thereof is predicated upon trash holding devices, and specifically, to an ergonomic trash receptacle and system for removal of garbage bags in an outward horizontal motion, as opposed to the conventional vertical lifting motion. According to the U.S. Environmental Protection Agency, municipal solid waste is commonly known as trash or garbage. Generally, it consists of paper, yard waste, metals, food, glass, wood, plastic, and miscellaneous materials. Some of these materials are biodegradable, which decompose over many years, while other materials such as glass and plastic are nondegradable. Trash disposal is critical in maintaining a cleaner environment and is also crucial for public health. A typical premise generates trash and garbage that require attention on a regular basis to maintain cleanliness, safety and health in the home or workplace. Having the proper equipment applies to waste management just as it does to other areas of good housekeeping or successful business operations. When an easy access to waste containers is availed, the overall maintenance of the premise is made easier, and premises stay cleaner and neater. Nothing says sloppy like overflowing trash cans or garbage cans inside or outside of a premise. It is important to purchase not only the right size cans and bins (collectively, devices), but also an adequate amount of such devices. Preferably, trash bins should be covered to prevent invasion by pests and insects, and to reduce odor. Furthermore, the use of specialized liners or trash bags help to control leakage and odors. The trash, if left loose and uncovered, can also create a fire hazard if scattered materials like paper are allowed to blow out of the cans and around the area. With the availability of so many different sizes, shapes and types of garbage bins and trash bins, there is absolutely no reason to not provide enough waste containers for any building or property. Trash and garbage containers are constructed of sturdy materials like stainless steel, plastic, wood or other metals. Some are camouflaged with decorative stone materials and exterior coverings, so they fit unobtrusively but effectively into exterior landscaping. Cans and bins are designed and created for use indoors and outdoors, each with strength to match their use. For easy handling, some larger cans and bins are equipped with rollers, wheels, or dollies, and special tops.

The standard trash receptacle is either a cylindrical or rectangular prism shape that is closed in on all sides and the base, with an opening at the top for inserting trash and removing a full trash bag, which may or may not be covered with a lid. The standard trash receptacle requires users to lift a full trash bag upwards in a vertical motion fighting against gravity. This method of removing a full trash bag is inconvenient; it can lead to shoulder and back injury, particularly for those with limited strength or mobility such as the elderly and disabled, as well as posing risk of injury to those who making repetitive lifting motions such as janitorial staff, especially when lifting heavier large sized commercial grade trash bags; and poses a greater challenge and further risk of injury to wheelchair users. Back pain is one of the most common types of pain experienced in the elderly and wheelchair users, and Repetitive Strain Injuries (RSI) and back injuries are among the leading cause of injury for janitorial workers. Furthermore, as per the Americans with Disabilities Act (ADA) standards described in the Accessible and Usable Building and Facilities guide ICC A117.1-2009, it is at the edge of acceptable tolerances for wheelchair users to have an unobstructed vertical reach up to 48″ from the floor which is roughly at or above shoulder height for most wheelchair users; the average full 13 gallon trash bag can weigh 15 pounds, the average 13 gallon trash can and trash bag are both roughly 24″ in height; and wheelchair users will often brace their balance using their off hand when leaning down to interact with a trash bag during removal; these constraints coupled together mean that often times a wheelchair user will have to use one hand to lift 15 pounds straight upward to a point roughly in line with their head to empty their trash can, which can pose significant challenges and strain.

However, despite the numerous trash receptacle options available, there is still a deficiency associated with the prior art regarding an ergonomic trash receptacle and system for removal of trash bags in an outward horizontal motion, as opposed to the conventional vertical lifting motion. In the prior art, there exists attempts to reduce the difficulties associated with lifting a full trash bag upward in a vertical motion, but these are insufficient. Among such prior art includes trash cans in which the body of the trash can separates from the base such that the body may be lifted up over the trash bag allowing the trash bag to be removed outward horizontally from the base with the body of the trash can no longer in the way, this however, is not ergonomic and does not sufficiently remedy the issues detailed above as users must still perform the lifting motion with the body of the trash can. Further existing prior art includes trash cans in which the trash can has a door on the front opening that is connected to and pivots at the base panel allowing the door to be lowered down onto the ground such that a trash bag may be removed outwards horizontally, this however, is not ergonomic and does not sufficiently remedy the issues detailed above as users must maneuver away from the trash can when lowering the door and reach all the way down to the ground when raising the door. Additionally, there exists in the prior art trash cans in which the trash can has a single door panel that is linked to one of the side walls of the trash can and a continuous trash bag that is tied off at the bottom end during use, then cut off and tied once the trash bag is full and ready to be removed, this however, is not ergonomic and does not sufficiently remedy the issues detailed above as users must maneuver away from the trash can when opening the door, and requires a level of manual dexterity such that a user can bend down to interact with the trash can and tie off the end of the bag. It is the object of this disclosure to provide remedy to the prior art.

### BRIEF SUMMARY OF THE INVENTION

The following summary is an explanation of some of the general inventive steps for the system, method, architecture, and apparatus in the description. This summary is not an extensive overview of the invention and does not intend to limit the scope beyond what is described and claimed as a summary.

In summary, the present invention, in some embodiments thereof, relates to an ergonomic trash receptacle for removal of trash bags in an outward horizontal motion, as opposed to the conventional vertical lifting motion. The elimination of the vertical lifting motion from the trash bag removal process decreases the strain of fighting against gravity, making it a safer and more convenient trash receptacle, particularly for those with limited mobility, such as the elderly and disabled, as well as reducing occupational hazards of janitorial staff who make repetitive motions of lifting trash bags on a routine basis.

The trash receptacle has at least a top opening for adding new trash and an anterior front opening to allow access for removal of the full trash bag. The anterior opening is preferably comprised of a door with two or more linked panels that collapse on themselves when moved to the open position. This positioning of door panels on the anterior face of the trash receptacle decreases the footprint over which the range of the door panels travel when being moved to the open position, allowing users to stand close to the trash receptacle without being hit by the door or needing to move out of the way

The trash receptacle has a retaining rack that includes two or more holding fixtures, with at least one or more of said holding fixtures being able to adjust position in respect to the other holding fixtures. The adjustable holding fixtures allows users to decrease the distance between all holding fixtures to be less than the circumference of the trash bag, which allows a fresh trash bag to be fastened more easily by reducing the struggle to place a trash bag taught around a fixed rim and provides a similar ease of use when removing a full trash bag. Furthermore, the adjustable holding fixtures allow users to move the retaining rack to a position in which the distance between all holding fixtures matches the trash bag's circumference, holding it taught in place during use.

The trash receptacle is preferably elevated on a stand, bringing the retaining rack to a higher elevation reducing the need to stoop and bend over to interact with the retaining rack.

### BRIEF DESCRIPTION OF THE SEVERAL VIEWS OF THE DRAWINGS

The novel features believed to be characteristic of the illustrative embodiments are set forth in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings, wherein:

FIG. 1 of the diagrams is an exemplary illustration of a ¾ view of the trash receptacle with the door and lid closed.

FIG. 2 of the diagrams is an exemplary illustration of a ¾ view of the trash receptacle with the door closed and lid open, exposing the retainer mechanism.

FIG. 3 of the diagrams is an exemplary illustration of a ¾ view of the trash receptacle with the door and lid open, exposing the retainer mechanism and the cavity of the trash receptacle.

FIG. 4 of the diagrams is an exemplary illustration of an overhead view of the retainer mechanism of the trash receptacle with the lid in the open position. FIG. 4 depicts four holding fixtures, the rear two holding fixtures are shown at the top of the diagram and are positioned toward the rear of the trash receptacle in the closed position, with the front two holding fixtures being shown at the bottom of the diagram in a fixed position.

FIG. 5 of the diagrams is an exemplary illustration of an overhead view of the retainer mechanism of the trash receptacle with the lid in the open position. FIG. 5 depicts four holding fixtures, the rear two holding fixtures are shown positioned toward the middle of the trash receptacle in the open position, with the front two holding fixtures being shown at the bottom of the diagram in a fixed position.

FIG. 6 of the diagrams is an exemplary illustration of a cross sectional view of the left wall and retainer mechanism of the trash receptacle. FIG. 6 depicts two of the holding fixtures, the rear holding fixture is shown at the right side of the diagram and is positioned toward the rear of the trash receptacle in the closed position, with the front holding fixture being shown at the left side of the diagram in a fixed position.

FIG. 7 of the diagrams is an exemplary illustration of a cross sectional view of the left wall and retainer mechanism of the trash receptacle. FIG. 7 depicts two of the holding fixtures, the rear holding fixture is shown positioned near the middle of the trash receptacle in the open position, with the front holding fixture being shown at the left side of the diagram in a fixed position.

FIG. 8 of the diagrams is an exemplary illustration of an overhead view of the trash receptacle with the lid open, depicting the door panel's path of travel swing footprint between the closed position and open position, with arc 14 showing the swing footprint of a singular door panel compared to arc 13 showing the swing footprint of a door with two panels linked laterally next to each other.

### DETAILED DESCRIPTION OF THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor can appropriately define the terms in order to describe the invention in the best way.

It is to be understood that the form of the invention shown and described herein is to be taken as a preferred embodiment of the present invention, so it does not express fully the technical spirit and scope of this invention. Accordingly, it should be understood that various changes and modifications may be made to the invention without departing from the spirit and scope thereof.

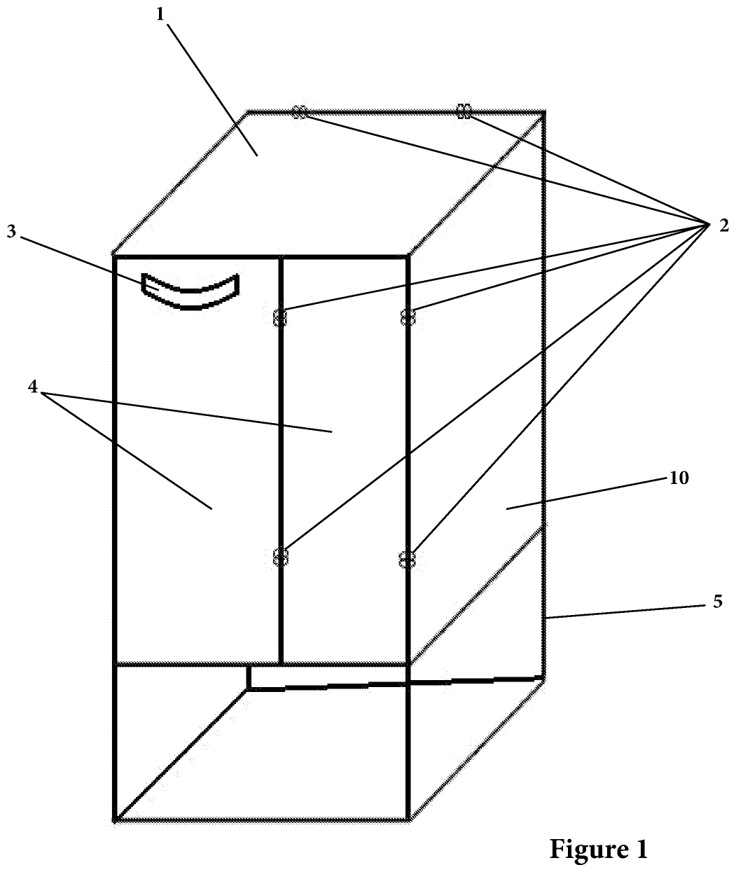

In a first embodiment of the trash receptacle shown in FIG. 1 of the diagrams is an exemplary illustration of a ¾ view of the trash receptacle with the door panels 4 and lid 1 closed. The trash receptacle preferably has a lid 1, which is linked to the back wall 11 through means such as hinges 2 as shown in FIG. 1, or through other means such as the lid 1 and back wall 11 being one continuous piece that can bend at the pivot point. The lid 1 may be moved between the closed position and open position through several means, including but not necessarily limited to being manually operated and held in either the closed position or open position using gravity and friction; using springs to move the lid 1 from the closed position to the open position being triggered by releasing a button, magnets, or clips that hold the lid 1 in the closed position until activated; a standard step pedal to hold the lid 1 in the open position when activated; or moved between the closed position and open position using a battery or wall outlet powered motor and activated using a trigger such as a button, motion sensor, voice activation, or assisted lifting of the lid 1. The trash receptacle preferably has two or more door panels 4 which are positioned laterally next to each other and linked together preferably using hinges 2 as shown in FIG. 1, or through other means such as the door panels 4 and side wall 10 being one continuous piece that can bend at the pivot points. The linkage between the door panels 4 allow for them to stack on themselves when moved to the open position, thus reducing the swing footprint for the path of travel of the door panels 4, allowing users to avoid being hit by the door panels 4 or having to move out of the way. The door panels 4 may be held in the closed position through several means, such as friction, magnets, hooks, or clips. One of the door panels 4 is shown with a handle 3 used to operate the door and move it between the closed position and open position. The trash receptacle is preferably elevated using a stand 5 to reduce the need to bend over when interacting with the trash receptacle.

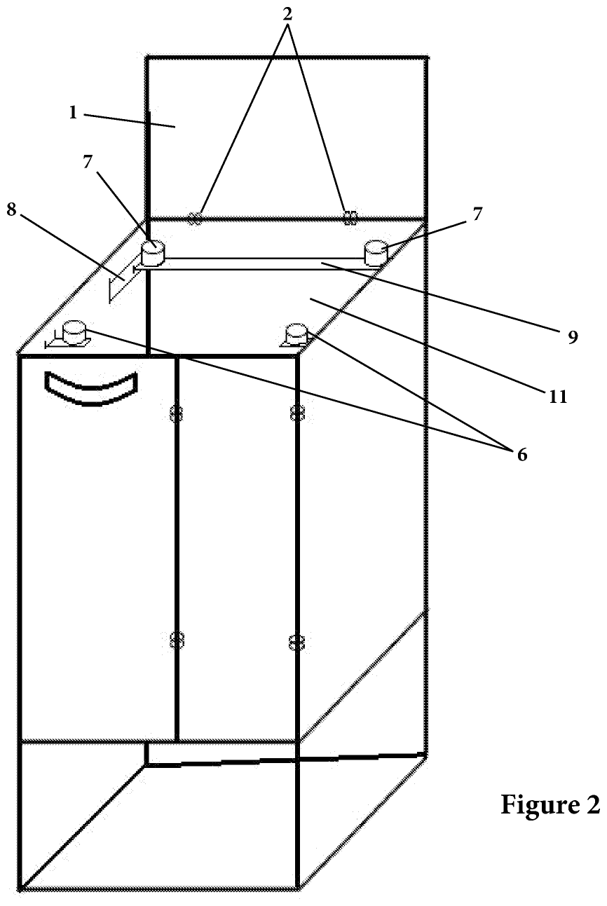

In a second embodiment of the trash receptacle shown in FIG. 2 of the diagrams is an exemplary illustration of a ¾ view of the trash receptacle with the door panels 4 in the closed position and lid 1 in the open position, with the lid 1 being linked to the back wall 11, preferably by hinges 2 or other linking methods, such as the lid 1 and back wall 11 being one continuous piece that bends at the pivot point. The lid 1 being in the open position exposes the retaining rack that holds open a trash bag, allowing users to insert trash into the trash bag. As shown in FIG. 2, the lid 1 is in the open position and the retaining rack and its components are exposed. The retaining rack is made up of two or more holding fixtures, in FIG. 2 there is a total of four holding fixtures shown, the fixtures may take on a variety of shapes to hold the bag open, such as a post shape as shown in FIG. 2, or other shapes such as a flat edge. The holding fixtures may be stationary in a fixed position, or adjustable in position; at least one holding fixture must be adjustable in its position. In FIG. 2 there are two front holding fixtures 6 that are shown to be stationary, and two rear holding fixtures 7 that are shown to be adjustable in position by using a slide 8 to move between a rear and middle position. The adjustable holding fixtures may move in a variety of motions, such as a linear forward and back sliding motion as shown in FIG. 2, or in other combinations of linear and pivoting motions along a horizontal and vertical plane. In FIG. 2 the rear holding fixtures are shown to be attached to each other with a flat bar 9 to allow them to adjust position in tandem, the holding fixtures may be attached to other holding fixtures in varying combinations to allow them to move in tandem or may be independent of each other.

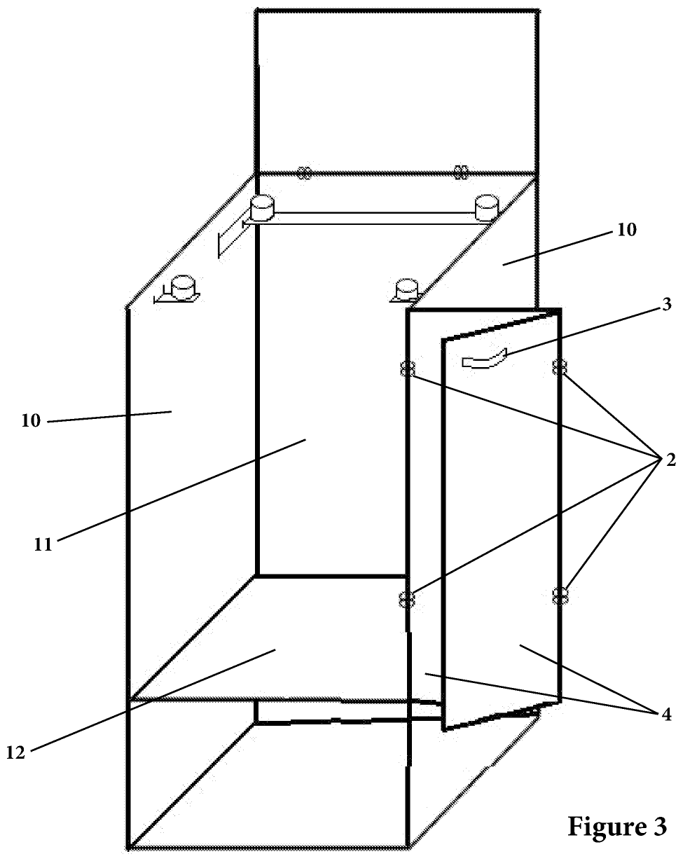

In another embodiment of the trash receptacle shown in FIG. 3 of the diagrams is an exemplary illustration of a ¾ view of the trash receptacle with the door panels 4 in the open position and lid 1 in the open position. The door panels 4 are shown to be linked together preferably using hinges 2 as shown in FIG. 3, or through other means such as the door panels 4 and the linked side wall 10 being one continuous piece that can bend at the pivot point. The door panels are shown in FIG. 3 to be in the open position, wherein the door panels 4 are stacked upon themselves, thus reducing the swing footprint of the path of travel of the door panels 4, allowing users to avoid being hit by the door panels 4 or having to move out of the way. The door panels 4 may be manipulated using a handle 3, making it easier to move the door panels 4 between the closed position and open position. FIG. 3 shows the door panels 4 in the open position, exposing the cavity of the trash receptacle, including both side walls 10, the back wall 11, and the base 12. Exposing the cavity of the trash receptacle allows for a full trash bag to be removed outward in the horizontal motion, rather than lifting the bag upward in a vertical motion. Preferably, the vertical distance between the base 12 and the holding fixtures is such that it allows for a standard trash bag to be fixed to the retaining rack and have the bottom of the trash bag rest on the base 12 so that the weight of a trash bag and its contents are held by the base and not the holding fixtures, with the holding fixtures main function being to keep the mouth of the trash bag open, rather than supporting the trash bag's weight.

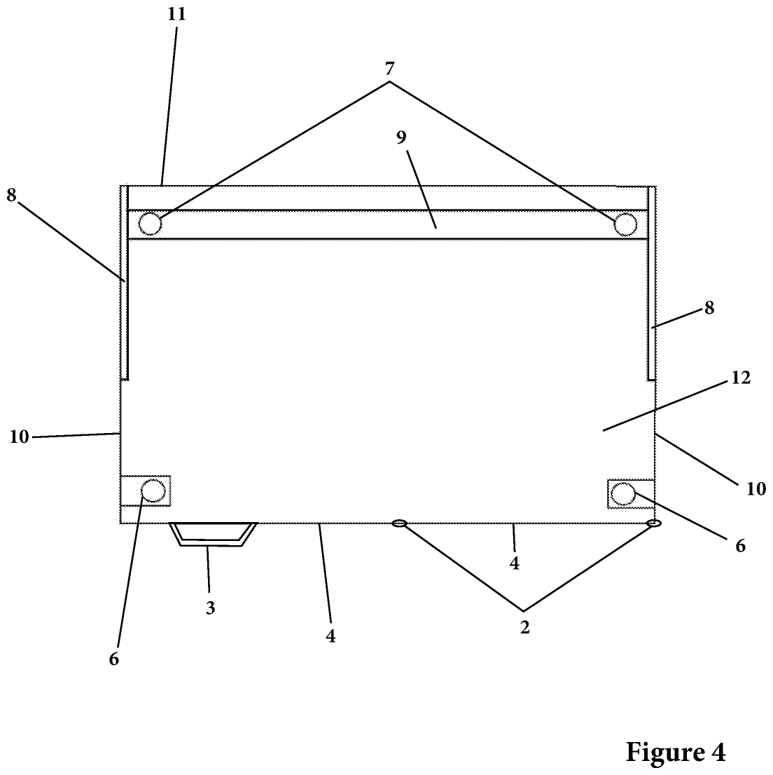

In the embodiment of the trash receptacle shown in FIG. 4 of the diagrams is an exemplary illustration of an overhead view of the retainer mechanism with four holding fixtures depicted. This view of the trash receptacle is bounded by the back wall 11 shown at the top of the diagram, the two side walls 10 on the left and right side of the diagram, and the hinged door panels 4 shown at the bottom of the diagram, with the hinges 2 linking the door panels and one of the side walls 10 together, as well as showing the handle 3 attached to one of the door panels 4. The two rear holding fixtures 7 are shown at the top of the diagram and are positioned toward the rear of the trash receptacle in the closed position, with the two front holding fixtures 6 being shown at the bottom of the diagram in a fixed position. The two rear holding fixtures 7 may be attached by a bar 9 that allows them to move in tandem in a forward and backward linear motion using the slide 8 mechanism. The rear holding fixtures 7 being positioned towards the rear of the trash receptacle allows for a trash bag to be held open and taut such that new trash can be inserted into the trash bag.

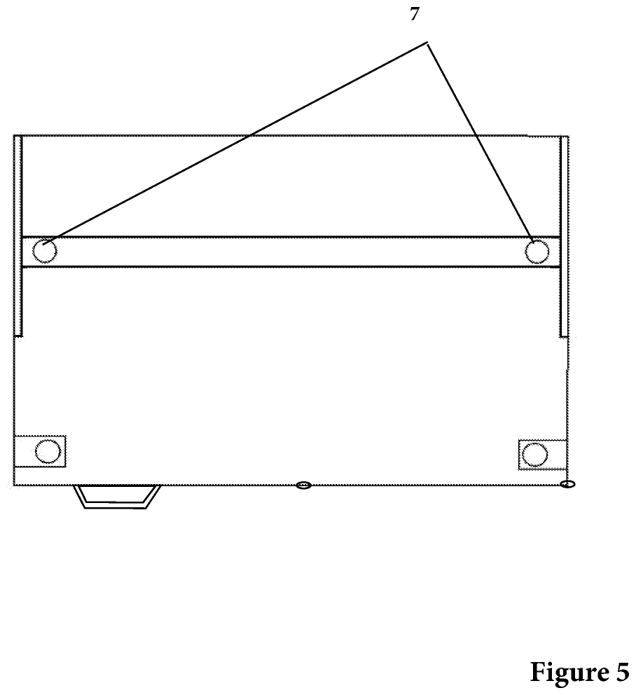

In the embodiment of the trash receptacle shown in FIG. 5 of the diagrams is an exemplary illustration of an overhead view of the retainer mechanism with four holding fixtures depicted, similar to the depiction of the trash receptacle in FIG. 4. As shown in FIG. 5, The two rear holding fixtures 7 are shown towards the middle of the diagram and are shown in the open position. The rear holding fixtures 7 being positioned towards the middle of the receptacle makes it easier for a new trash bag to be fixed to the retainer mechanism or a full trash bag to be removed from the retainer mechanism as the trash bag will no longer be taut around the holding fixtures.

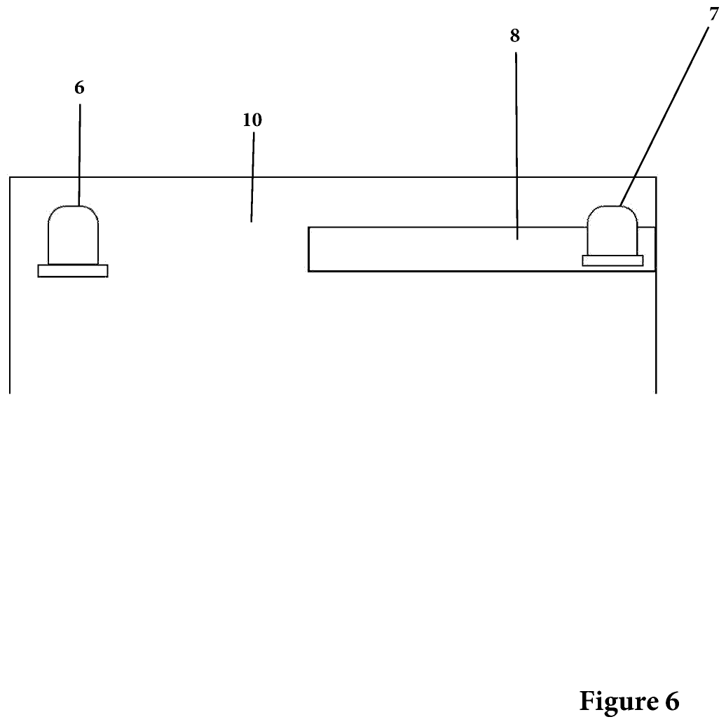

In the embodiment of the trash receptacle shown in FIG. 6 of the diagrams is an exemplary illustration of a cross sectional view of the left side wall 10 and retainer mechanism with two of the holding fixtures depicted. The rear holding fixture 7 is shown toward the right side of the diagram and is positioned along the slide 8 toward the rear of the trash receptacle in the closed position, with the front holding fixture 6 being shown at the left side of the diagram in a fixed position. FIG. 6 offers an alternate view of the retainer mechanism in the same position as depicted in FIG. 4.

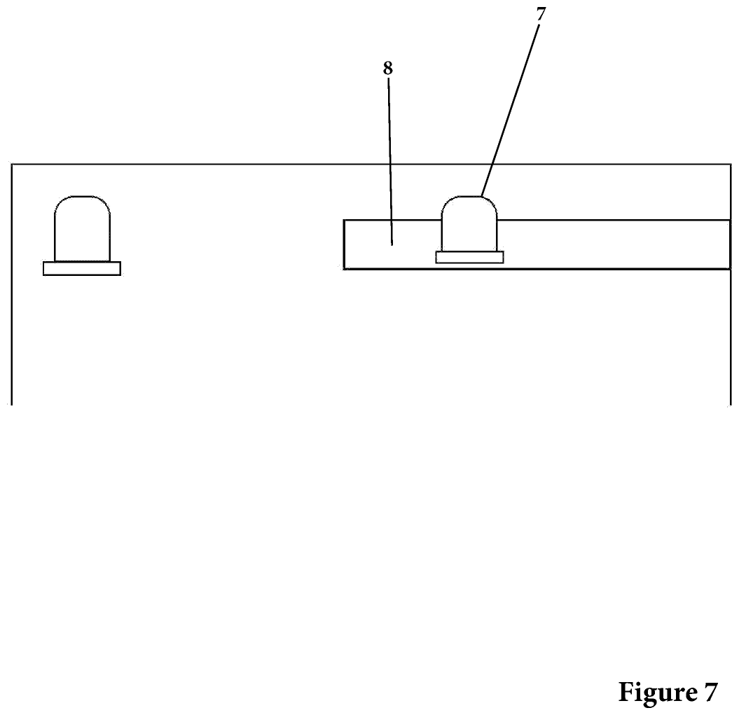

Further still in the embodiment of the trash receptacle shown in FIG. 7 of the diagrams is an exemplary illustration of a cross sectional view similar to FIG. 6. As shown in FIG. 7, the rear holding fixture 7 is positioned along the slide 8 toward the middle of the trash receptacle in the open position. FIG. 7 offers an alternate view of the retainer mechanism in the same position as depicted in FIG. 5.

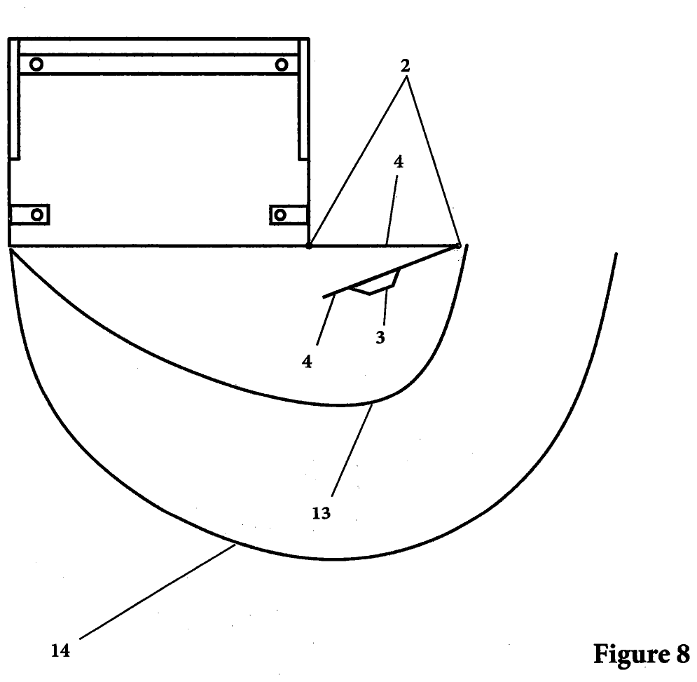

In the final embodiment of the trash receptacle shown in FIG. 8 of the diagrams is an exemplary illustration of an overhead view of the trash receptacle similar to FIG. 4, with the door panels 4 in the open position, linked together by hinges 2, having been moved to the open position using the handle 3. FIG. 8 shows the door panel's 4 swing footprint path of travel between the closed and open positions, with the outer arc 14 showing the swing footprint path of travel for a singular door panel which incurs a significantly wide arc, as compared to the inner arc 13 showing the aforementioned trash receptacle door panels 4 swing footprint path of travel characterized by two or more panels that are linked laterally next to each other, which incurs a significantly narrower swing footprint than that of a singular door panel.

The present embodiment of the trash receptacle is shown to be in the shape of a rectangular prism, with a back wall, two side walls, a base wall, an operable lid concealing the top opening, an operable door comprised of two linked door panels sealing the anterior opening, and a retaining mechanism comprised of a total of four bag holding fixtures, with two of said bag holding fixtures being fixed in position located toward the anterior opening of the trash receptacle, and the remaining two bag holding fixtures being adjustable in position located toward the rear back wall of the trash receptacle.

The trash receptacle may take on a variety of geometric three dimensional shapes, which may include a rectangular prism, cylindrical shape, triangular prism, or hexagonal prism, furthermore the trash receptacle may be closed in or open on its various faces, including the sides, back, or base; the trash receptacle is not defined by its geometric shape but rather that it allows a space for a trash bag to reside with access to the anterior and top faces of the trash bag such that new trash may be inserted into the trash bag through the top opening and the trash bag may be removed from the receptacle through the anterior opening.

Additionally, the trash receptacle's bag holding fixtures may take on a variety of geometric shapes, which may include a cylindrical post shape, a flat edge, or a rectangular prism, and may hold the bag in place through a variety of means, which may include friction, clips, hooks, magnets, pinching, or high grip materials. Furthermore, the trash receptacles retaining mechanism may take on a variety of quantities of bag holding fixtures which may include two, three, four or more bag holding fixtures. At least one or more of the bag holding fixtures must be able to adjust its position relative to at least one or more of the other bag holding fixtures. The bag holding fixture may adjust its position by a change in position along a combination of horizontal, vertical, and rotational planes using a variety of motions which may include linear or rotational motions. The trash receptacle and it's retaining mechanism are not defined by a specific shape or quantity of bag holding fixtures, but rather that there are at least two or more bag holding fixtures wherein at least one or more of the bag holding fixtures is able to adjust its position relative to the other bag holding fixtures, such that the distance between bag holding fixtures can be made to be less than that of the circumference of the mouth of a trash bag, allowing the trash bag to easily be fastened or removed from the bag holding fixtures, as well as the bag holding fixtures being able to have their positions adjusted to match the circumference of the mouth of a trash bag such that the trash bag is held open and taut to allow new trash to be inserted into the trash bag.

The trash receptacle must have an anterior opening to allow access for a trash bag to be removed and a top opening to allow access for new trash to be inserted into the trash bag. The anterior opening of the trash receptacle is sealed by an operable door, which may be left in the closed position to help prevent the diffusion of odors, improve aesthetics, and prevent unwanted access by pests, or moved to an open position to allow access for the trash bag to be removed outward in a horizontal motion. The door is comprised of two or more linked panels that are positioned laterally next to each other. The door panels and side wall may be linked together through a variety of means, which may include hinges or the door panels and side wall being one continuous piece that bends at the pivot point. The door may be held in the closed position against the non-linked side wall through a variety of means, which may include friction, hooks, clips, or magnets. The linked door panels may take on a variety of quantity of individual door panels that are equal to two or more door panels, which may include two, three, four or more individual door panels. The trash receptacle is not defined by how the door panels are linked or held in the closed position but rather by the quantity of linked door panels being equal to a number of two or more, and that the door panels are able to stack upon themselves such that the swing footprint path of travel for the multiple door panels is reduced in comparison to the swing footprint path of travel for a singular door panel, helping users to avoid the need to move away from the trash receptacle when moving the door to the open position or being hit by the door when moving the door to the open position.

The preferred manner of operating the trash receptacle include the following steps: the lid is moved to the open position, the door on the anterior opening is moved to the open position with the door panels stacking on themselves, the retainer mechanism is moved to the open position such that the distance between bag holding fixtures is less than the circumference of the mouth of the trash bag, if a full trash bag is currently held by the retainer mechanism then the trash bag is detached from the retainer mechanism and removed from the trash receptacle outward in a horizontal motion, a fresh trash bag is attached to the retainer mechanism, the retainer mechanism is moved to the closed position such that the distance between the bag holding fixtures is equal to the circumference of the mouth of the trash bag and the trash bag is held open and taut, the door is moved to the closed position, the lid is moved to the closed position.

The foregoing is provided for purposes of illustrating, explaining, and describing embodiments of the present invention. Modifications and adaptations to these embodiments will be apparent to those skilled in the art and may be made without departing from the scope or spirit of the invention.

### INDUSTRIAL APPLICATION

The current invention technology is applicable to trash and garbage storage and disposal systems.

1. A trash receptacle to accommodate a trash bag, comprising of a space to be occupied by the trash bag, an anterior opening, a top opening, and a trash bag retaining mechanism with two or more trash bag holding fixtures.

2. A trash receptacle as in claim 1, wherein the retaining mechanism is comprised of at least one of said bag holding fixtures being adjustable in position with respect to one or more of the other bag holding fixtures.

3. A trash receptacle as in claim 1, wherein the anterior opening is sealed by an operable door comprised of two or more linked door panels positioned laterally next to each other.
